(19) United States
(12) Patent Application Publication
(10) Pub. No.: US 2014/0327744 A1
(43) Pub. Date: Nov. 6, 2014

(54) IMAGE PROCESSING APPARATUS, METHOD THEREOF, AND NON-TRANSITORY COMPUTER READABLE STORAGE MEDIUM

(71) Applicant: SONY CORPORATION, Minato-ku, Tokyo (JP)

(72) Inventor: Kenji Gotoh, Chiba (JP)

(73) Assignee: SONY CORPORATION, Minato-ku, Tokyo (JP)

(21) Appl. No.: 14/356,292

(22) PCT Filed: Oct. 29, 2012
(86) PCT No.: PCT/JP2012/006926

§ 371 Date: May 5, 2014

(30) Foreign Application Priority Data
Dec. 12, 2011 (JP) 2011-271070

(51) Int. Cl. H04N 13/02

(52) U.S. Cl. CPC H04N 13/0225
USPC 348/49

(57) ABSTRACT

An image processing apparatus, image processing method and computer program product perform image processing to suppress an amount of parallax adjustment based on a posture of the image processing apparatus. The apparatus includes a parallax control unit that adjusts a position of an object in a left image and in a right image captured by an imaging device based on detected movement of the imaging device during an imaging operation. The left image and the right image are configured to be displayed together as a stereoscopic image.

### TECHNICAL FIELD

The present technology relates to an image processing device. Specifically, the technology relates to an image processing device dealing with stereoscopic images, a control method thereof, and a computer program product that executes the method in a computer.

### BACKGROUND ART

In the related art, an image processing device such as a digital still camera, or a digital video camera (for example, a camera-integrated recorder, or the like) which records a plurality of images (image data) for displaying a stereoscopic image which is able to obtain three-dimensional vision using parallax of left and right eyes by being associated with each other.

When a user views the stereoscopic image which is recorded in this manner, there may be a case where the focal distance becomes different even when the real world and the convergence angle are the same as each other. For this reason, it is important to reduce an unnatural feeling of a user which is caused by such a reason.

Therefore, a parallax conversion device has been proposed in which, for example, a parallax control parameter for performing an appropriate parallax control using left and right images of an input image is generated, and content of image conversion processing is controlled according to the parallax control parameter (for example, refer to PTL 1).

### CITATION LIST

### Patent Literature

PTL 1: JP 2011-55022A

### SUMMARY

### Technical Problem

According to the above described related art, when displaying a stereoscopic image after being subject to a parallax adjustment, it is possible to show the stereoscopic image naturally, and comfortably, by performing the parallax adjustment with respect to the stereoscopic image.

Here, for example, by sequentially displaying any one of the left eye image and the right eye image for displaying the stereoscopic image (moving image), it is possible to display stereoscopic image content as a planar image (moving image). However, when the stereoscopic image after being subject to the parallax adjustment is displayed as the planar image, there is a concern that the planar image becomes difficult to see, since a user feels the parallax change due to the parallax adjustment unnatural.

The present technology has been produced in light of this situation, and an object thereof is to provide image content which is easily viewed by a user.

### Solution to Problem

As a non-limiting example, an image processing apparatus is described that includes a parallax control unit that adjusts a position of an object in a left image and in a right image captured by an imaging device based on detected movement of the imaging device during an imaging operation of the imaging device. The left image and the right image are configured to be displayed together as a stereoscopic image. A corresponding method and non-transitory computer program product are also described.

### Advantageous Effects of Invention

According to the present technology, excellent effects capable of providing image content which is easily viewed by a user can be provided.

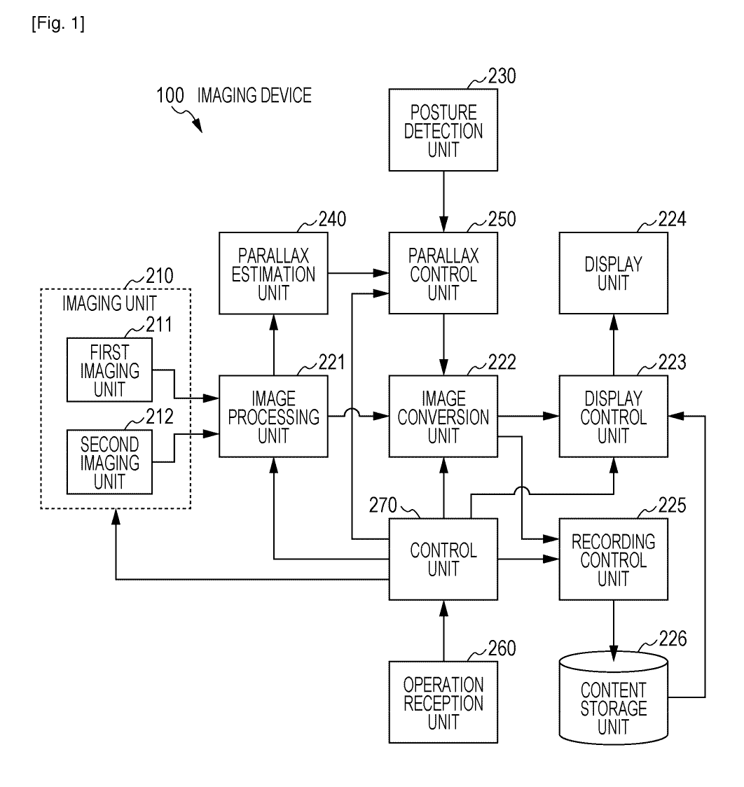

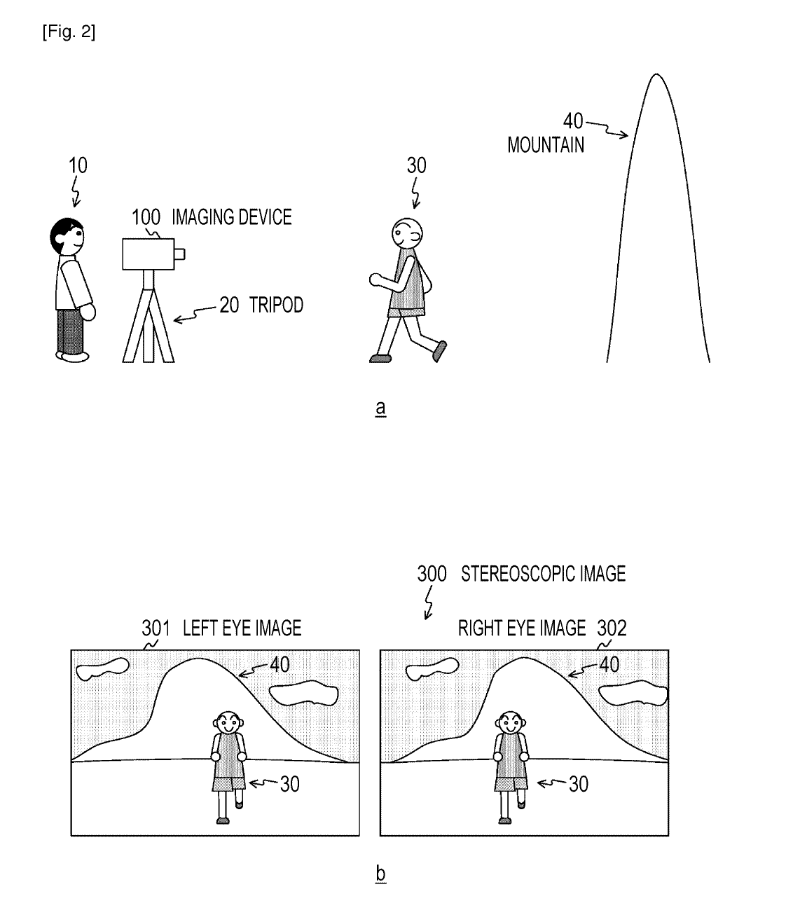

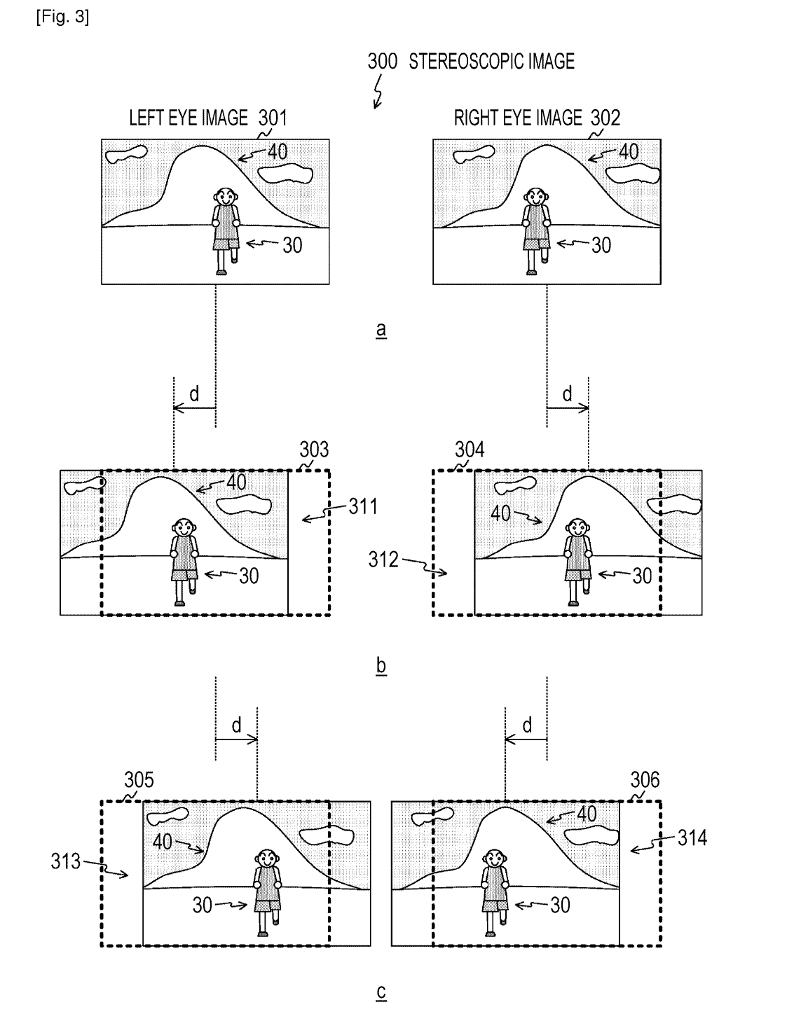

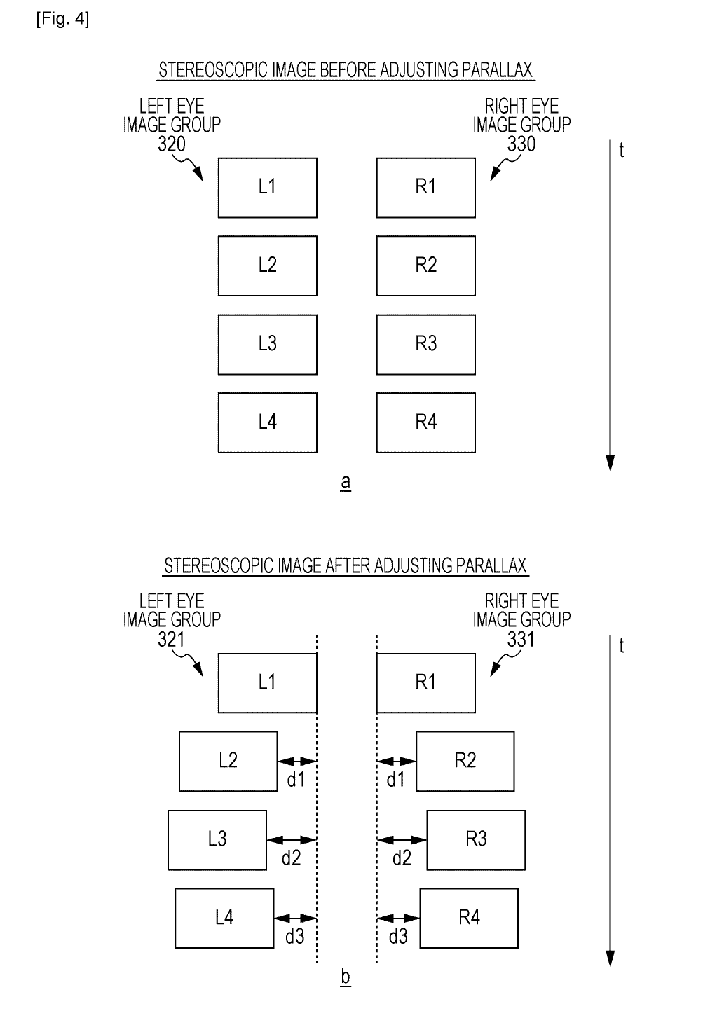

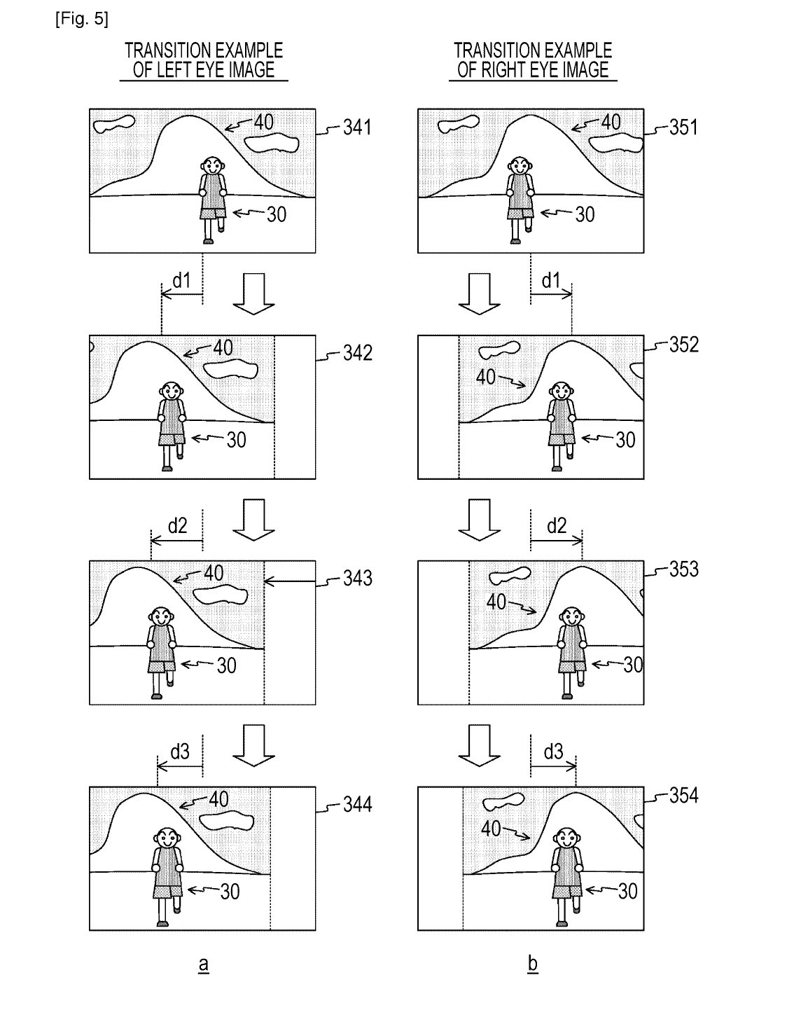

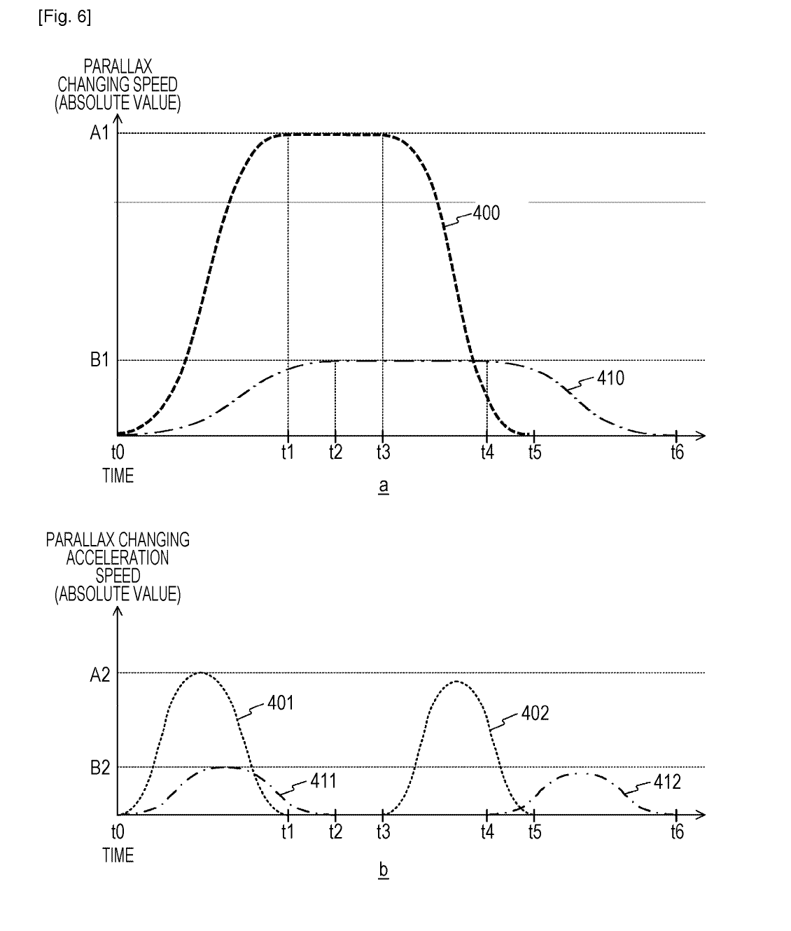

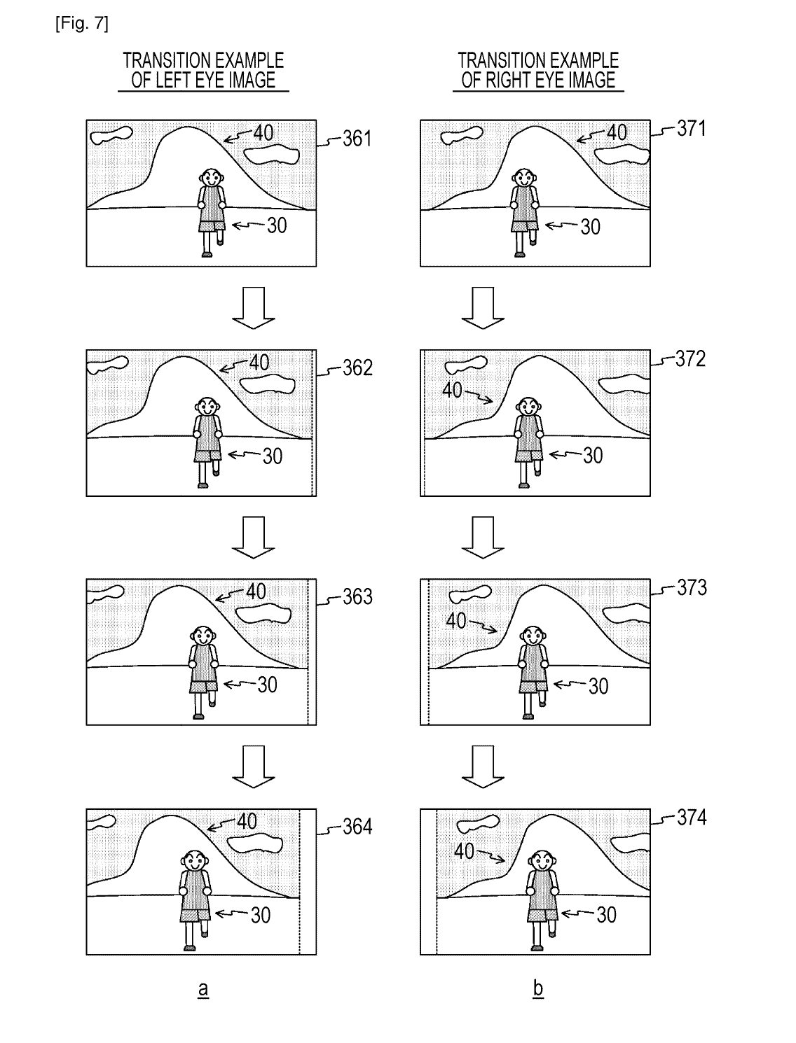

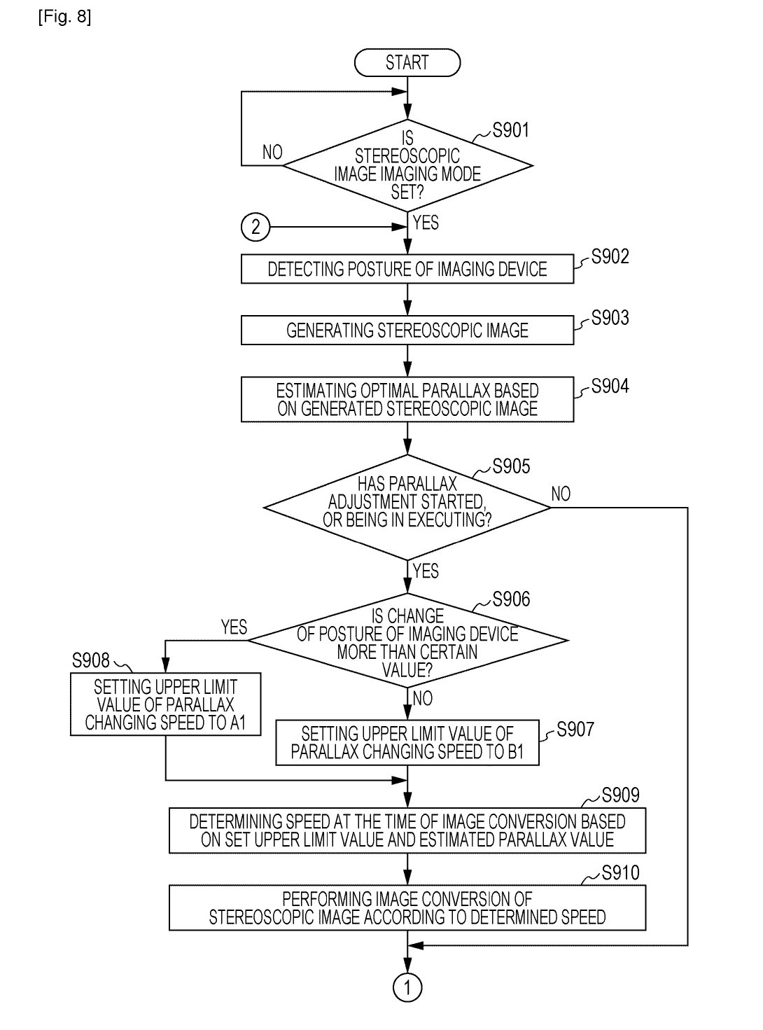

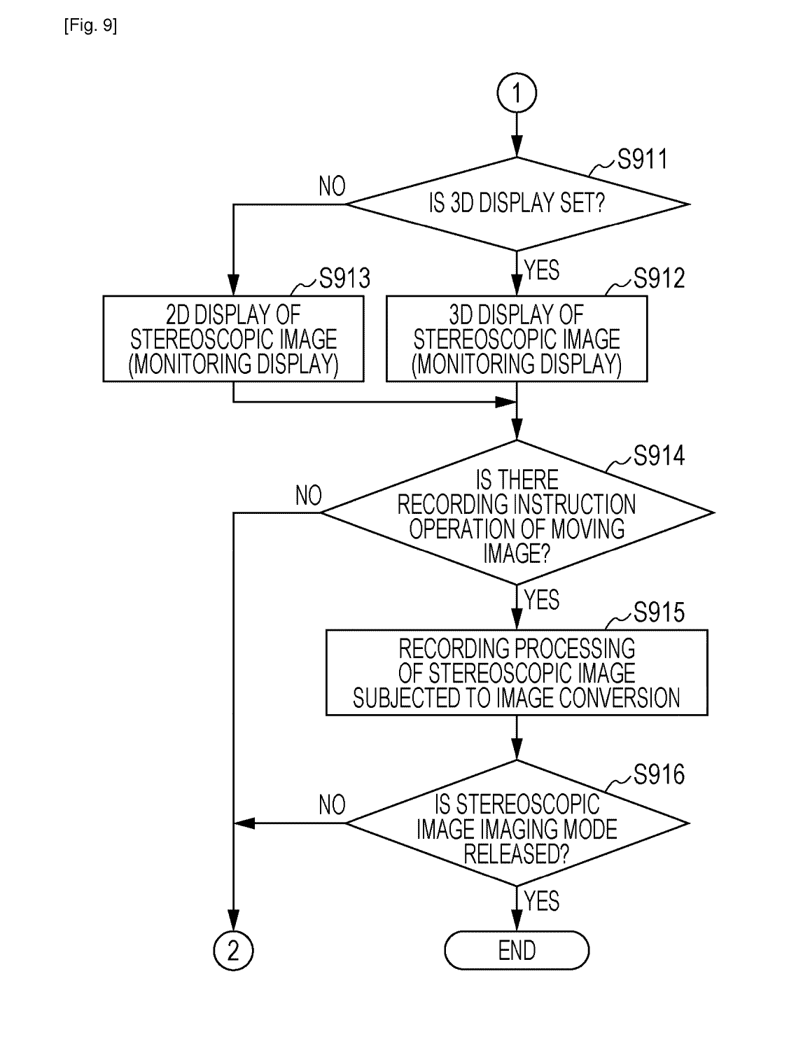

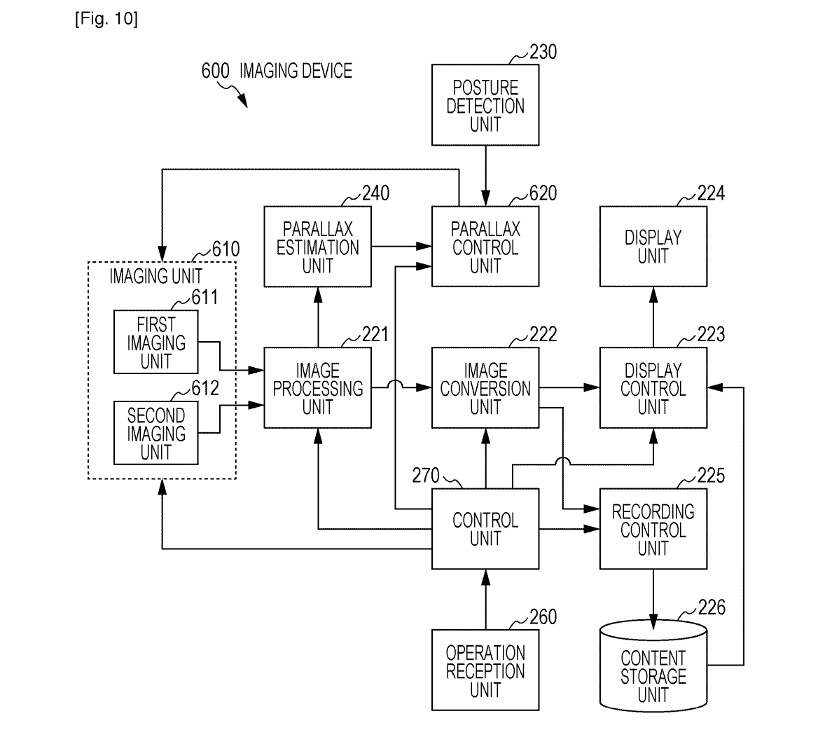

### BRIEF DESCRIPTION OF DRAWINGS

[FIG. 1] FIG. 1 is a block diagram which shows a configuration example of an imaging device 100 according to a first embodiment of the present technology.

[FIG. 2] FIG. 2 is a diagram which schematically shows an example of an imaging operation which is performed using the imaging device 100, and a stereoscopic image which is generated by the imaging operation.

[FIG. 3] FIG. 3 is a diagram which schematically shows an example of an image conversion which is performed by an image conversion unit 222 according to the first embodiment of the present technology.

[FIG. 4] FIG. 4 is a diagram which schematically shows a transition of the stereoscopic image in time sequence, which is subject to the image conversion by the image conversion unit 222 according to the first embodiment of the present technology.

[FIG. 5] FIG. 5 is a diagram which schematically shows the transition of displaying the stereoscopic image as a time sequence, when displaying the stereoscopic image which is recorded by the imaging device 100 according to the first embodiment of the present technology.

[FIG. 6] FIG. 6 is a diagram which shows an example of a limit amount which is used when limiting an image conversion (parallax adjustment) performed by the image conversion unit 222 according to the first embodiment of the present technology.

[FIG. 7] FIG. 7 is a diagram which schematically shows the transition of displaying the stereoscopic image as a time sequence, when displaying the stereoscopic image which is recorded by the imaging device 100 according to the first embodiment of the present technology.

[FIG. 8] FIG. 8 is a flowchart which shows an example of a recording processing order of the stereoscopic image by the imaging device 100 according to the first embodiment of the present technology.

[FIG. 9] FIG. 9 is a flowchart which shows an example of a recording processing order of the stereoscopic image by the imaging device 100 according to the first embodiment of the present technology.

[FIG. 10] FIG. 10 is a block diagram which shows a functional configuration example of an imaging device 600 according to a second embodiment of the present technology.

### DESCRIPTION OF EMBODIMENTS

Hereinafter, embodiments for implementing the present technology (hereinafter, referred to as embodiments) will be described. Descriptions will be made in the following order.

1. First Embodiment (an example of recording control of stereoscopic image: an example of controlling a parallax adjustment of the stereoscopic image on the basis of a state of imaging operation at the time of imaging operation of the stereoscopic image)

2. Second Embodiment (an example of limiting the parallax adjustment of an imaging device which performs the parallax adjustment of the stereoscopic image by adjusting a convergence angle of two imaging units)

### 1. First Embodiment

“Configuration Example of Imaging Device”

FIG. 1 is a block diagram which shows a configuration example of an imaging device 100 according to a first embodiment of the present technology.

The imaging device 100 includes an imaging unit 210, an image processing unit 221, an image conversion unit 222, a display control unit 223, a display unit 224, a recording control unit 225, and a content storage unit 226. In addition, the imaging device 100 includes a posture detection unit 230, a parallax estimation unit 240, a parallax control unit 250, an operation reception unit 260, and a control unit 270. In addition, the imaging device 100 is an example of an image processing apparatus which is described in the scope of the claim of the invention.

The imaging unit 210 is an imaging unit which generates a planar image including a subject by photographing the subject, or a stereoscopic image for a stereoscopic vision of the subject on the basis of a control of the control unit 270, and includes the first and second imaging units 211 and 212.

The first and second imaging units 211 and 212 are configured by an optical system, and an imaging element of one pair, respectively, on the left and right. In addition, each configuration of the first and second imaging units 211 and 212 (each optical system, each imaging element, or the like) is approximately the same as each other, excepting for different arranging positions. For this reason, hereinafter, the configuration will be described by omitting a part of any one of these left and right configurations.

The first imaging unit 211 includes an imaging element (not shown) which converts light which is input through the optical system (not shown) to an electrical signal, and an analog signal processing unit (not shown) which performs processing of an output signal (analog signal) of the imaging element. That is, in the first imaging unit 211, an optical image of a subject which is input through the optical system is formed on the imaging surface of the imaging element, and the analog signal is generated by performing an imaging operation by the imaging element in this state. In addition, an image signal is generated when an analog signal processing unit performs analog processing such as an amplification, or noise removal with respect to the analog signal. In addition, the generated image signal (analog signal) is output to the image processing unit 221. In addition, as the imaging element, for example, it is possible to use a CCD (Charge coupled Device), a CMOS (Complementary Metal Oxide Semiconductor), or the like.

In addition, the optical system of the first imaging unit 211 is configured by a lens group which condenses incident light from a subject, or a diaphragm, and the light which is condensed by the lens group is input to the imaging element through the diaphragm. In addition, the lens group is configured by a focus lens for focusing, a zoom lens for enlarging the subject, or the like. In addition, each lens configuring the optical system is driven on the basis of an instruction of the control unit 270, and functions of focusing and zooming are executed by being moved back and forth with respect to the subject.

In addition, the imaging unit 210 performs the imaging processing corresponding to an imaging mode which is set by the control unit 270. Here, as the imaging mode, any one of imaging modes of a planar image imaging mode and a stereoscopic image imaging mode. The planar image imaging mode is an imaging mode in which any one of the first and the second imaging units 211 and 212 generates a planar image by imaging the subject, and records the planar image. In addition, the stereoscopic image imaging mode is an imaging mode in which the first and the second imaging units 211 and 212 image the subject, respectively, and generates a stereoscopic image (left eye image and right eye image) for making the subject stereoscopic, and records the stereoscopic image.

In addition, in each of these imaging modes, it is assumed that setting any one of a still image imaging mode for recording a still image and a moving image imaging mode for recording a moving image is possible. That is, when any one of imaging modes of the planar image imaging mode and the stereoscopic image imaging mode is set, it is possible to perform both the still image recording operation and the moving image recording operation on the basis of an operation of a user.

In addition, the first imaging unit 211 outputs a generated image (for example, the left eye image) to the image processing unit 221, and the second imaging unit 212 outputs a generated image (for example, the right eye image) to the image processing unit 221.

The image processing unit 221 converts the image signal (analog signal) which is output from the imaging unit 210 on the basis of the instruction from the control unit 270, and performs various image processing with respect to an image signal (digital signal) which is generated by the conversion. In addition, the image processing unit 221 outputs the image signal (image data) which is subject to the various image processing to the image conversion unit 222 and the parallax estimation unit 240.

The image conversion unit 222 is a unit for performing an image conversion with respect to the image signal (image data) which is output from the image processing unit 221 on the basis of an instruction from the parallax control unit 250, and outputs the image signal (image data) after being subject to the image conversion to the display control unit 223 and the recording control unit 225. For example, when an image signal (image data) of the stereoscopic image is output from the image processing unit 221, the image conversion unit 222 performs an image conversion (parallax adjustment) with respect to the stereoscopic image. That is, the image conversion unit 222 performs the image conversion which changes the parallax of the left eye image and the right eye image according to an amount of parallax which is set by the parallax control unit 250. Here, the parallax adjustment means adjusting a position of an object included in the stereoscopic image in the depth direction.

For example, the image conversion unit 222 performs the image conversion (parallax adjustment) by performing shift processing in which a relative position of the left eye image and the right eye image which configure the stereoscopic image which is output from the image processing unit 221 is shifted in the horizontal direction. In addition, the image conversion unit 222 performs the image conversion (parallax adjustment) by performing scaling processing in which the whole screen is enlarged or reduced in the horizontal direction based on a predetermined position (a position in the horizontal direction). In addition, the image conversion unit 222 may perform a two-stage image conversion (parallax adjustment) in which the above described each processing is performed in two stages (for example, refer to Japanese Unexamined Patent Application Publication No. 2011-55022) with respect to each of the left eye image and the right eye image. In this manner, by performing the two-stage image conversion, it is possible to reproduce more natural stereoscopic vision. In addition, the image conversion unit 222 is an example of the image conversion unit which is described in the scope of the claim of the invention.

The display control unit 223 is a unit which displays an image signal (image data) which is output from the image conversion unit 222 on the display unit 224 on the basis of a control from the control unit 270. For example, the display control unit 223 displays the image signal (image data) which is output from the image conversion unit 222 on the display unit 224 as a through-image (monitoring image) when the imaging mode is set.

The display unit 224 is a display panel which displays each image on the basis of the control of the control unit 270. For example, an image (through-image) in the imaging processing which is input in real time in the middle of imaging processing is displayed on the display unit 224. In this manner, it is possible for a user to operate the imaging device 100 while viewing the through-image in the middle of imaging operation on the display unit 224. In addition, when a playback instruction operation of image content which is stored in the content storage unit 226 is performed, the display unit 224 displays image content which is relating to the playback instruction operation. For example, as the display unit 224, it is possible to use a display panel such as an LCD (Liquid Crystal Display), an organic EL (Electro Luminescence) panel, or the like. In addition, as the display unit 224, it is possible to use a display panel which is capable of displaying any of the stereoscopic image and the planar image.

The recording control unit 225 is a unit which performs a recording control with respect to the content storage unit 226 on the basis of an instruction of the control unit 270. For example, the recording control unit 225 records an image signal (image data) which is output from the image conversion unit 222 in the content storage unit 226 as image content (a still image file, or a moving image file). In addition, for example, the recording control unit 225 compresses the image signal (image data) using a predetermined compact encoding method when a recording button (not shown) is pressed, in a case where the stereoscopic image imaging mode is set. In addition, the compressed image signal is recorded in the content storage unit 226 as the moving image content (stereoscopic image content). Further, the recording control unit 225 compresses the image signal (image data) using the predetermined compact encoding method when a shutter button (not shown) is pressed, in a case where the stereoscopic image imaging mode is set. In addition, the compressed image signal is recorded in the content storage unit 226 as the still image content (stereoscopic image content).

The content storage unit 226 is a recording medium which records various information (image content, or the like) on the basis of a control of the recording control unit 225. In addition, the content storage unit 226 may be built into the imaging device 100, or may be provided in the imaging device 100 so as to be detachable therefrom.

The posture detection unit 230 is a unit which detects a change in posture of the imaging device 100 by detecting acceleration, a motion, a slope, or the like of the imaging device 100, and posture information relating to the change in posture of the imaging device 100 is output to the parallax control unit 250. That is, the posture detection unit 230 detects whether or not the imaging device 100 is stopped, or detects that the change in position, or the posture of the imaging device 100 is small. In addition, as the posture detection unit 230, for example, it is possible to use a gyro sensor. By using the gyro sensor, it is possible to detect an angular velocity of the imaging device 100, and the change in posture of the imaging device 100. In addition, it is also possible to detect the posture, and the change in position of the imaging device 100 based on a detection result, by detecting the acceleration, the motion, the slope, or the like of the imaging device 100 using other sensors (for example, an acceleration sensor) other than the gyro sensor. In addition, the posture detection unit 230 is an example of a posture detection unit which is described in the scope of the claim of the invention.

In addition, it is also possible to detect the change in posture of the imaging device 100 on the basis of an image generated by the imaging unit 210. For example, the image processing unit 221 detects a movement amount and the moving direction between images which are close to each other in time axis, with respect to the image which is generated by the imaging unit 210. In addition, the image processing unit 221 outputs information relating to the detected movement amount and the moving direction (movement information) to the parallax control unit 250 as posture information relating to the change in posture of the imaging device 100. For example, the image processing unit 221 performs matching processing between pixels which configure two images which are close to each other (that is, matching processing which discriminates imaging areas of the same subject), and calculates the number of pixels which are moved in between each image. In the matching processing, basically, the processing is performed by assuming that the subject is at rest. In addition, when a moving body is included in the subject, a motion vector which is different from a motion vector of the whole image is detected, however, the motion vector corresponding to the moving body is processed as non-detection target. That is, only the motion vector corresponding to the motion of the whole image (GMV: Global Motion Vector) which is generated along with the movement of the imaging device 100 is detected.

The parallax estimation unit 240 generates a parallax control parameter by estimating a parallax in the image signal (image data) of the stereoscopic image which is output from the image processing unit 221, and analyzing the parallax on the basis of a control of the control unit 270. In addition, the parallax estimation unit 240 outputs the generated parallax control parameter to the parallax control unit 250. That is, the parallax estimation unit 240 estimates a comfortable parallax amount on the basis of the stereoscopic image (left eye image and right eye image) which is output from the image processing unit 221.

For example, the parallax estimation unit 240 estimates a parallax on the basis of the left eye image which is generated by the first imaging unit 211 and the right eye image which is generated by the second imaging unit 212, and generates a parallax map. The parallax map is a map which maintains a parallax of pixels, or a parallax of each pixel group which configure the stereoscopic image (left eye image and right eye image). In this case, as the stereoscopic image, any one of the left eye image and the right eye image can be used as a reference. In addition, as a method of estimating the parallax, a well-known estimation method can be used. For example, it is possible to use a technology (for example, refer to Japanese Unexamined Patent Application Publication No. 2006-114023) in which a parallax of the left and right images is estimated, and a parallax map is generated, by performing the matching with respect to a foreground image in which a background image is excluded from the left and right images.

In addition, the parallax estimation unit 240 generates a parallax control parameter for performing an appropriate parallax control by analyzing the generated parallax map. Specifically, the parallax estimation unit 240 generates a histogram of a parallax from the parallax map, and determines a parallax control parameter so that a distribution of the histogram is to fit within an appropriate range (for example, refer to Japanese Unexamined Patent Application Publication No. 2011-55022).

In addition, when an input operation relating to the parallax control parameter is performed in the operation reception unit 260, the parallax estimation unit 240 may generate a parallax control parameter relating to the input operation, and output the generated parallax control parameter to the parallax control unit 250. In this case, it is possible to set a parallax control parameter depending on a user's preference.

The parallax control unit 250 performs a control of the image conversion (parallax adjustment) which is performed by the image conversion unit 222 in order to transit the parallax amount of the stereoscopic image to a comfortable parallax amount on the basis of the control of the control unit 270. That is, the parallax control unit 250 performs the control of the image conversion (parallax adjustment) which is performed by the image conversion unit 222 on the basis of a parallax control parameter which is output from the parallax estimation unit 240. In addition, the parallax control unit 250 performs a control for limiting the image conversion (parallax adjustment) on the basis of a detection result (a state of imaging operation at the time of imaging operation of the stereoscopic image) on the basis of the detection result from the posture detection unit 230. For example, the parallax control unit 250 limits a parallax changing speed by the image conversion unit 222, or stops the change in parallax, when the imaging device 100 is stopped, or the change in position, or posture of the imaging device 100 is small. In addition, the limitation of the parallax adjustment will be described in detail with reference to FIGS. 6 and 7. In addition, the parallax control unit 250 is an example of a parallax control unit which is described in the scope of the claim of the invention.

The operation reception unit 260 is a unit for receiving operations which are performed by a user, and outputs a control signal (operation signal) corresponding to received operation content to the control unit 270.

The control unit 270 is a unit for controlling each unit in the imaging device 100 on the basis of a control program which is stored in a memory (not shown). For example, the control unit 270 performs a control corresponding to an operation input from a user which is received by the operation reception unit 260.

“Examples of Imaging Operation and Stereoscopic Image”

FIG. 2 is a diagram which schematically shows examples of an imaging operation which is performed using the imaging device 100 according to the first embodiment of the present technology, and a stereoscopic image which is generated by the imaging operation.

In FIG. 2, “a” shows a state of imaging operation performed using the imaging device 100 which is fixed to a tripod 20 when seen from the side thereof. Specifically, the figure shows a state where the imaging operation is performed by a photographer 10 using the imaging device 100 with a runner 30, and a mountain 40 as subjects. In this case, it is assumed that a distance of the runner 30 from the imaging device 100 (subject distance) is relatively close, and the subject distance of the mountain 40 is relatively far.

In FIG. 2, “b” shows stereoscopic images 300 (left eye image 301 and right eye image 302) which are generated by the imaging operation performed using the imaging device 100. Specifically, the figure shows the left eye image 301 which is generated by the first imaging unit 211, and the right eye image 302 which is generated by the second imaging unit 212, in a state shown in “a” of FIG. 2.

In this manner, in a state shown in “a” of FIG. 2, it is possible to generate the stereoscopic images 300 (left eye image 301, and right eye image 302) by performing the imaging operation using the imaging device 100 to which the stereoscopic image imaging mode is set.

Here, as shown in “a” of FIG. 2, a case is assumed in which moving image content of a stereoscopic image in which an object (runner 30) moving in the optical axis direction of the imaging device 100 is imaged is played. When playing the moving image content of the stereoscopic image, it is assumed that the object (runner 30) which is moving in the optical axis direction while performing imaging operation overshoots in the display screen.

Therefore, in such a case, it is possible to provide a stereoscopic image which is easily viewed by a user by adjusting parallaxes of the left eye image 301 and the right eye image 302 which configure the stereoscopic images 300 (for example, refer to Japanese Unexamined Patent Application Publication No. 2011-55022). An example of this parallax adjustment is shown in FIG. 3.

“Example of Parallax Adjustment of Stereoscopic Image”

FIG. 3 is a diagram which schematically shows an example of an image conversion which is performed by the image conversion unit 222 according to the first embodiment of the present technology. FIG. 3 shows an example of performing shift processing as the parallax adjustment.

In FIG. 3, “a” shows the stereoscopic images 300 (left eye image 301, and right eye image 302) which are generated by the imaging operation in the state shown in “a” of FIG. 2. That is, the stereoscopic image in a state of not performing the shift processing (that is, shift amount s=0) is shown in “a” of FIG. 3. In addition, since the stereoscopic images 300 is the same as those in “b” of FIG. 2, descriptions thereof will be omitted.

In FIG. 3, “b” and “c” show a state in which the image conversion unit 222 performs the shift processing with respect to the stereoscopic images 300 which is shown in “a” of FIG. 3. In addition, rectangles 303 to 306 which are formed with thick and dotted lines shown in “b” and “c” of FIG. 3 denote image areas as recording targets. In addition, areas 311 to 314 remaining as blanks due to each shift processing are surplus areas.

In FIG. 3, “b” shows a stereoscopic image in a state of being subject to the shift processing (that is, shift amount s>0) in the direction in which the left eye image and the right eye image are away from each other by the image conversion unit 222.

For example, the parallax control unit 250 determines a shift amount s (s=2d>0) on the basis of a parallax control parameter which is determined by the parallax estimation unit 240. In addition, the image conversion unit 222 performs the shift processing such that a coordinate of each pixel in the horizontal direction is shifted in the left eye image 301 to the left by the d pixel, and a coordinate of each pixel in the horizontal direction is shifted in the left eye image 302 to the right by the d pixel.

In FIG. 3, “c” shows a stereoscopic image in a state of being subject to the shift processing (that is, shift amount s<0) in the direction in which the left eye image and the right eye image are close to each other by the image conversion unit 222.

For example, the parallax control unit 250 determines a shift amount s (s=2d<0) on the basis of a parallax control parameter which is determined by the parallax estimation unit 240. In addition, the image conversion unit 222 performs the shift processing such that a coordinate of each pixel in the horizontal direction is shifted in the left eye image 301 to the right by the d pixel, and a coordinate of each pixel in the horizontal direction is shifted in the right eye image 302 to the left by the d pixel.

In this manner, “b” and “c” of FIG. 3 schematically show a stereoscopic image in a case of being subject to the shift processing such that the respective left eye image 301 and the right eye image 302 are shifted by the d pixel (that is, 2d pixels in total).

In addition, the parallax adjustment shown in FIG. 3 is an example, and it is also possible to perform another parallax adjustment. For example, as described above, it is also possible to perform the parallax adjustment using the scaling processing.

“Transition Example of Parallax Adjustment of Stereoscopic Image”

FIG. 4 is a diagram which schematically shows a transition of a stereoscopic image in time sequence, which is subject to the image conversion by the image conversion unit 222 according to the first embodiment of the present technology.

In FIG. 4, “a” shows stereoscopic images (left eye image group 320, and right eye image group 330) before being subject to the image conversion (parallax adjustment) by aligning thereof along a time axis. In addition, “b” of FIG. 4 shows stereoscopic images (left eye image group 321, and right eye image group 331) after being subject to the image conversion (parallax adjustment) by aligning thereof along a time axis. In addition, “a” and “b” of FIG. 4 schematically show each of images as outlined rectangles, and denote each rectangle by attaching a reference numeral therein. Specifically, each left eye image configuring the left eye image group 320 is attached with Ln, and each right eye image configuring the right eye image group 330 is attached with Rn (here, n=1 to 4). In addition, an image of which a generation time is the earliest is set to n=1, and an image of which the generation time is the slowest is set to n=4.

In addition, in “b” of FIG. 4, for ease of description, the shift amount relating to the image conversion which is performed with respect to the stereoscopic image is relatively largely shown. Specifically, each of left eye image L2 and right eye image R2 is assumed to be subject to the shift processing so as to be shifted by a dl pixel from a reference position (denoted by dotted lines). In addition, each of left eye image L3 and right eye image R3 is assumed to be subject to the shift processing so as to be shifted by a d2 pixel from the reference position (denoted by dotted lines). Further, each of left eye image L4 and right eye image R4 is assumed to be subject to the shift processing so as to be shifted by a d3 pixel from the reference position (denoted by dotted lines).

“Display Example of Stereoscopic Image After Parallax Adjustment”

FIG. 5 is a diagram which schematically shows a display transition of a stereoscopic image when displaying a stereoscopic image which is recorded by the imaging device 100 according to the first embodiment of the present technology.

In FIG. 5, “a” shows an example of a display transition of left eye images 341 to 344. In addition, “b” of FIG. 5 shows an example of a display transition of right eye images 351 to 354. In addition, the left eye image 341 in “a” of FIG. 5 corresponds to the left eye image 301 in “a” of FIG. 3, and the right eye images 351 in “b” of FIG. 5 corresponds to the right eye image 302 in “a” of FIG. 3.

In addition, in FIG. 5, similarly to “b” of FIG. 4, for ease of description, a shift amount relating to the image conversion which is performed with respect to the stereoscopic image is relatively largely shown. In addition, the shift amount (d1 to d3) is the same as that in “b” of FIG. 4.

As described above, when playing image content (stereoscopic image content) which is stored in the content storage unit 226, the stereoscopic image is easy to view for a user if the stereoscopic image which is subject to the above described parallax adjustment is displayed.

Here, when playing the stereoscopic image content, there is a display device (for example, the display unit 224, and a stereoscopic television) which allows a user to be able to view any of stereoscopic image (3D image) and planar image (2D image) according to a preference of a user. Therefore, for example, a case is assumed in which the stereoscopic image content is played using the display device. In this case, for example, it is possible to view the stereoscopic image as the planar image (2D image) by sequentially displaying only one of images (for example, left eye image) of the left eye image and the right eye image which configure the stereoscopic image. For example, by displaying the left eye images 341 to 344 shown in “a” of FIG. 5, it is possible to view the stereoscopic image as the planar image (2D image).

Here, the image conversion (parallax adjustment) which is performed by the image conversion unit 222 is an image conversion for making the stereoscopic image easy to view. For this reason, when the stereoscopic image which is subject to the image conversion (parallax adjustment) (for example, the left eye images 341 to 344 shown in “a” of FIG. 5, and the right eye images 351 to 354 shown in “b” of FIG. 5) by the image conversion unit 222, the image is easy to view for a user.

However, when the stereoscopic image which is subject to the image conversion by the image conversion unit 222 is viewed as the planar image (for example, the left eye images 341 to 344 shown in “a” of FIG. 5), there is a case where the image after the image conversion (parallax adjustment) becomes an unnatural image.

For example, as shown in “a” of FIG. 5, the left eye image 342 which is displayed after displaying the left eye image 341 is shifted in the horizontal direction by a shift amount d1 when the left eye image 341 is set as a reference. In addition, the left eye image 343 which is displayed after displaying the left eye image 342 is shifted in the horizontal direction by a shift amount (d2-d1) when the left eye image 342 is set as a reference. In addition, the left eye image 344 which is displayed after displaying the left eye image 343 is shifted in the horizontal direction by a shift amount (d3-d2) when the left eye image 343 is set as a reference.

For this reason, when the left eye images 341 to 344 shown in “a” of FIG. 5 are displayed as planar images, the subject included in each image is viewed by being extremely vibrated, laterally. In particular, in a state where the imaging device 100 is stopped (for example, the device is fixed to the tripod 20, as shown in “a” of FIG. 2), the lateral vibration stands out. In addition, there is also a case where the left end portions of the left eye images 342 to 344 shown in “a” of FIG. 5 are now shown.

Therefore, according to the first embodiment of the present technology, the parallax adjustment of the stereoscopic image is limited on the basis of the imaging operation state at the time of imaging operation of the stereoscopic image. In this manner, it is possible to make a user view the stereoscopic image easily, when the stereoscopic image is displayed as the planar image.

“Limitation Example of Parallax Adjustment”

FIG. 6 is a diagram which shows an example of an amount of limit which is used for limiting the image conversion (parallax adjustment) performed by the image conversion unit 222 according to the first embodiment of the present technology.

In FIG. 6, “a” shows a curve of parallax changing speed (curves 400 and 410) corresponding to two patterns for performing a certain limit with respect to the image conversion, when the image conversion unit 222 performs the image conversion (parallax adjustment) with respect to the stereoscopic image.

Here, the curve 400 is a curve which corresponds to a first pattern which is applied when the change in posture of the imaging device 100 is detected by the posture detection unit 230, and has the upper limit value of A1. In addition, the curve 410 is a curve which corresponds to a second pattern which is applied when the change in posture of the imaging device 100 is not detected by the posture detection unit 230, and has the upper limit value of B1.

Here, it is possible to set the upper limit value A1 of the curve 400 to, for example, approximately 1/60 (frame/sec)×1 pixel. In addition, it is possible to set the upper limit value B1 of the curve 410 to, for example, approximately ¼ to ⅛ of the upper limit value A1. For example, it is possible to set the upper limit value B1 to, for example, approximately 1/60 (frame/sec)×0.25 pixel.

In addition, a termination time of the curve 400 t5, and a termination time of the curve 410 t6 are assumed to be calculated on the basis of a parallax parameter which is determined by the parallax estimation unit 240.

In FIG. 6, “b” shows curve of parallax change acceleration corresponding to the curve of parallax change speed shown in “a” of FIG. 6. That is, the curves of parallax change acceleration shown in “b” of FIG. 6 are curves (curves 401, 402, 411, and 412) which show accelerations in each interval corresponding to the curve of parallax change speed shown in “a” of FIG. 6.

Here, the curve 401 is the curve of parallax change acceleration corresponding to the curve 400 (shown in “a” of FIG. 6) in intervals t0 to t1, and the curve 402 is the curve of parallax change acceleration corresponding to the curve 400 in intervals t3 to t5. In addition, the upper limit value of the curve of parallax change acceleration (curves 401 and 402) corresponding to the curve 400 is set to A2.

In addition, the curve 411 is the curve of parallax change acceleration corresponding to the curve 410 (shown in “a” of FIG. 6) in intervals t0 to t2, and the curve 412 is the curve of parallax change acceleration corresponding to the curve 410 in intervals t4 to t6. In addition, the upper limit value of the curve of parallax change acceleration (curves 401 and 402) corresponding to the curve 410 is set to B2.

As described above, the lateral vibration stands out in a fixed-state where the imaging device 100 is stopped (for example, as shown in “a” of FIG. 2, the device is fixed to the tripod 20). In contrast to this, the lateral vibration rarely stands out in a state where the imaging device 100 is operating (for example, a held-state where a photographer is holding the imaging device 100).

Therefore, when a change in posture of the imaging device 100 is detected by the posture detection unit 230, the first pattern (curve 400) is used, and when the change in posture of the imaging device 100 is not detected by the posture detection unit 230, the second pattern (curve 410) is used.

Here, a case will be assumed and described in which, in a state shown in “a” of FIG. 2, the image conversion unit 222 performs the shift processing (parallax adjustment) with respect to a stereoscopic image which is generated by the imaging unit 210.

For example, as shown in “b” of FIG. 3, the parallax estimation unit 240 determines a parallax control parameter for shifting the coordinate of each pixel of the left eye image 301 in the horizontal direction to the left by d pixel. In addition, since the imaging device 100 is fixed to the tripod 20 in the state shown in “a” of FIG. 2, the change in posture of the imaging device 100 is not detected by the posture detection unit 230. For this reason, the parallax control unit 250 determines to use the second pattern (curve 410). In this case, the parallax control unit 250 calculates a time (t6) in a case where the second pattern (curve 410) is used on the basis of the parallax control parameter which is determined by the parallax estimation unit 240. That is, a time (t6) is calculated, which is necessary to reach a target value for performing the parallax adjustment (shifting to the left by d pixel) corresponding to the parallax control parameter which is determined by the parallax estimation unit 240.

Subsequently, when a parallax adjustment (shifting to the left by d pixel) corresponding to a parallax control parameter which is determined by the parallax estimation unit 240 is performed, the parallax control unit 250 determines a shift speed according to the curve 410, while reaching the target value (d pixel to the left). That is, a shift speed and the acceleration until reaching the target value for performing the parallax adjustment (shifting to the left by d pixel) corresponding to the parallax control parameter determined by the parallax estimation unit 240 are determined. In addition, the image conversion unit 222 performs the shift processing according to the shift speed which is determined by the parallax control unit 250.

For example, since the shift speed is 0 at the time t0 in the curve 410, the image conversion unit 222 does not perform the shift processing. Subsequently, since the shift speed increases between the time t0 and time t2 in the curve 410, the image conversion unit 222 performs the shift processing while sequentially accelerating the shift speed. In this case, the shift speed becomes an acceleration corresponding to the curve 411 shown in “b” of FIG. 6.

Subsequently, since the speed is constant between the time t2 and time t4 in the curve 410, the image conversion unit 222 performs the shift processing while maintaining the constant shift speed. Subsequently, since the speed is decreased between the time t4 and time t6 in the curve 410, the image conversion unit 222 performs the shift processing while sequentially delaying the shift speed. In this case, the shift speed becomes an acceleration corresponding to the curve 412 shown in “b” of FIG. 6.

In this manner, it is possible to prevent a rapid change in speed by performing the parallax adjustment using the shift speed corresponding to the curve 410. Due to this, it is possible to provide a more friendly planar image in user's eyes.

In addition, when a change in posture of the imaging device 100 is detected by the posture detection unit 230, it is possible to perform the parallax adjustment using the shift speed corresponding to the curve 400.

Here, a case is assumed in which the change in posture of the imaging device 100 is not detected by the posture detection unit 230, when the change in posture of the imaging device 100 is detected by the posture detection unit 230, and the parallax adjustment is performed using the shift speed corresponding to the curve 400. In this case, the upper limit value is changed from A1 to B1, and the shift speed is changed so as to become the shift speed corresponding to the curve 410 from the shift speed corresponding to the curve 400, and the parallax adjustment is performed. In addition, a case is assumed in which the change in posture of the imaging device 100 is detected by the posture detection unit 230, when the change in posture of the imaging device 100 is not detected by the posture detection unit 230, and the parallax adjustment is performed by the shift speed corresponding to the curve 410. In this case, similarly, the upper limit value is changed from B1 to A1, and the shift speed is changed so as to become the shift speed corresponding to the curve 400 from the shift speed corresponding to the curve 410, and the parallax adjustment is performed.

In this manner, the parallax control unit 250 performs a control for limiting the parallax adjustment on the basis of the state of imaging operation at the time of imaging operation of the stereoscopic image. That is, the parallax control unit 250 performs the control for limiting the parallax adjustment on the basis of the detection result from the posture detection unit 230.

In this case, the parallax control unit 250 strongly limits the parallax adjustment in a case where the change (in posture) is smaller than a predetermined value, compared to a case where the change in posture of the imaging device 100 is larger than the predetermined value. For example, the parallax control unit 250 strongly limits the parallax adjustment in a case where the change is not detected (curve 410), compared to a case where the change in posture of the imaging device 100 is detected (curve 400). That is, the parallax control unit 250 sets the upper limit value for controlling the parallax adjustment small in a case where the change is smaller than the predetermined value, compared to a case where the change in posture of the imaging device 100 is larger than the predetermined value. For example, the upper limit value in a case where the change is not detected (upper limit value B1 of the curve 410) is set small, compared to the upper limit value in a case where the change in posture of the imaging device 100 is detected (upper limit value A1 of the curve 400).

In addition, the parallax control unit 250 controls the parallax adjustment by controlling the speed or, acceleration of change at the time of image changing in the horizontal direction when performing image processing by the image conversion unit 222. In this case, the parallax control unit 250 limits the parallax adjustment by setting the upper limit value of the speed, or the acceleration. For example, when the change in posture of the imaging device 100 is not detected (that is, the imaging device 100 is stopped), B1 is set as the upper limit value of the speed, and B2 is set as the upper limit value of the acceleration.

In addition, in the example, a case where the change in posture of the imaging device 100 is not detected (that is, the imaging device 100 is stopped), and the parallax adjustment is performed using the shift speed corresponding to the curve 410 is shown. However, for example, when the change in posture of the imaging device 100 is not detected (that is, the imaging device 100 is stopped), the parallax adjustment may be stopped. In this case, the parallax control unit 250 performs a control for stopping the parallax adjustment.

In addition, in the example, a case is shown, in which, when the change in posture of the imaging device 100 is detected, a certain limit is provided to the speed, or the acceleration, by performing the parallax adjustment using the shift speed corresponding to the curve 400. However, it is also possible to perform the best parallax adjustment (parallax adjustment corresponding to the parallax control parameter which is determined by the parallax estimation unit 240) without providing the limit, when the posture of the imaging device 100 is detected.

“Display Example of Stereoscopic Image With Limitation of Parallax Adjustment”

FIG. 7 is a diagram which schematically shows a display transition of the stereoscopic image which is recorded by the imaging device 100 according to the first embodiment of the present technology in time sequence.

In FIG. 7, “a” shows an example of display transition of the left eye images 361 to 364. In addition, “b” of FIG. 7 shows an example of display transition of the right eye images 371 to 374. In addition, the left eye images 361 to 364 shown in “a” of FIG. 7 are images which are performed with the limitation of the parallax adjustment with respect to the left eye images 341 to 344 shown in “a” of FIG. 5. In addition, the right eye images 371 to 374 shown in “b” of FIG. 7 are images which are performed with the limitation of the parallax adjustment with respect to the right eye images 351 to 354 shown in “b” of FIG. 5.

Here, a case is assumed in which the stereoscopic image is viewed as the planar image (2D image) by sequentially displaying only one image (for example, left eye image) of the left eye image and the right eye image configuring the stereoscopic image. For example, it is possible to view the stereoscopic image as the planar image (2D image) by sequentially displaying the left eye images 361 to 364 shown in “a” of FIG. 7. In this manner, it is possible to prevent the subject included in each image from being viewed extremely vibrated, laterally, when displaying the left eye images 361 to 364 which are performed with the limitation of parallax adjustment.

In addition, for example, a case is assumed in which, as shown in “a” of FIG. 2, the through-image (2D image) which is displayed in the display unit 224 is viewed by the photographer 10 in a state where the imaging device 100 is fixed to the tripod 20. In this case, as well, it is possible to prevent the subject included in the through-image (2D image) which is displayed in the display unit 224 from being viewed extremely vibrated, laterally. For this reason, when the photographer 10 operates the imaging device 100 while viewing the through-image which is being imaged on the display unit 224, it is possible to make the through-image easy to view.

“Operation Example of Imaging Device”

FIGS. 8 and 9 are flowcharts which show an example of a procedure of recording processing of the stereoscopic image by the imaging device 100 according to the first embodiment of the present technology.

First, the control unit 270 determines whether or not the stereoscopic image is set to the imaging mode (step S901), and continues monitoring when the stereoscopic image imaging mode is not set to the imaging mode. On the other hand, when the stereoscopic image imaging mode is set (step S901), the posture detection unit 230 detects the posture of the imaging device 100 (step S902). Subsequently, the imaging unit 210 generates the stereoscopic image, and the image processing unit 221 performs the image processing with respect to the stereoscopic image (step S903).

Subsequently, the parallax estimation unit 240 estimates a parallax which is optimal for the stereoscopic image, on the basis of the stereoscopic image (step S904). That is, the parallax estimation unit 240 generates the parallax control parameter (step S904). Subsequently, the parallax control unit 250 determines whether it is necessary to start the parallax adjustment on the basis of the generated parallax control parameter which is generated by the parallax estimation unit 240, or the image conversion unit 222 is executing the image conversion (parallax adjustment) (step S905). When it is not necessary to start the parallax adjustment, or when the image conversion unit 222 is not executing the image conversion (parallax adjustment) (step S905), the process proceeds to step S911. In addition, a case where it is not necessary to start the parallax adjustment is, for example, a case where the parallax amount corresponding to the parallax control parameter generated by the parallax estimation unit 240 is 0.

When it is necessary to start the parallax adjustment, and when the image conversion unit 222 is executing the image conversion (parallax adjustment) (step S905), the parallax control unit 250 determines whether or not the posture of the imaging device 100 has changed more than a certain value (step S906). That is, the parallax control unit 250 determines whether or not the posture of the imaging device 100 has changed more than a certain value on the basis of the posture of the imaging device 100 which is detected by the posture detection unit 230 (step S906).

In addition, when the imaging device 100 has changed more than a certain value (step S906), the parallax control unit 250 sets A1 (upper limit value A1 in “a” of FIG. 6) as the upper limit value of the parallax change speed (step S908). That is, when the imaging device 100 is moving, the image conversion (parallax adjustment) is performed according to the first pattern (curve 400) in which the upper limit value A1 is relatively high.

On the other hand, when the imaging device 100 has not changed more than a certain value (step S905), the parallax control unit 250 sets B1 (upper limit value B1 in “a” of FIG. 6) as the upper limit value of the parallax change speed (step S907). That is, when the imaging device 100 is stopped, the image conversion (parallax adjustment) is performed according to the second pattern (curve 410) in which the upper limit value B1 is relatively low.

Subsequently, the parallax control unit 250 determines the speed at the time of image conversion on the basis of the parallax which is estimated by the parallax estimation unit 240, and the set upper limit value (upper limit value A1, or B1) (step S909). That is, the speed at the time of image conversion is determined according to the first pattern (curve 400), or the second pattern (curve 410).

Subsequently, the image conversion unit 222 performs the image conversion (parallax adjustment) with respect to the stereoscopic image which is subject to the image processing by the image processing unit 221, on the basis of the speed determined by the parallax control unit 250 (step S910). In addition, steps S906 to S910 are examples of an adjusting step described in the scope of the claim of the invention.

Subsequently, the control unit 270 determines whether or not the 3D display is set as a monitoring display (step S911). In addition, when the 3D display is not set as the monitoring display (step S911), the display control unit 223 displays the stereoscopic image which is subject to the image conversion by the image conversion unit 222 as the planar image on the display unit 224 (step S913). For example, only the left eye image is displayed on the display unit 224 (step S913).

On the other hand, when the 3D display is set as the monitoring display (step S911), the display control unit 223 displays the stereoscopic image which is subject to the image conversion by the image conversion unit 222 on the display unit 224 (step S912).

Subsequently, the control unit 270 determines whether or not a recording instruction operation of a moving image is performed (for example, the first press operation of a recording button) (step S914), and returns to step S902 when the recording instruction operation of the moving image is not performed. On the other hand, when the recording instruction operation of the moving image is performed (step S914), the recording control unit 225 performs the recording processing for recording the stereoscopic image which is subject to the image conversion by the image conversion unit 222 in the content storage unit 226 as the stereoscopic image content (step S915).

Subsequently, the control unit 270 determines whether or not a release operation of the stereoscopic image imaging mode is performed (step S916), and return to step S902 when the release operation of the stereoscopic image imaging mode is not performed. On the other hand, when the release operation of the stereoscopic image imaging mode is performed (step S916), the operation of recording processing is ended.

In addition, in the example, it is shown that the first pattern, or the second pattern is set as the parallax change speed according to whether or not the posture of the imaging device 100 is changed more than a certain value. However, for example, it is possible to set a pattern corresponding to the change in posture of the imaging device 100, by preparing three or more pattern corresponding to the change in posture of the imaging device 100, and choosing one among each of these patterns.

In addition, it is also possible to set only one upper limit value of the parallax change speed and the parallax change acceleration according to whether or not the posture of the imaging device 100 is changed more than a certain value. For example, it is also possible to set the upper limit value by preparing two or more upper limit values corresponding to the change in posture of the imaging device 100, and set the upper limit values corresponding to the change in posture of the imaging device 100 among each of the upper limit values. That is, it is also possible to make the upper limit value variable depending on the size of the movement of the imaging device 100.

### 2. Second Embodiment

According to the first embodiment of the present technology, an example is shown in which the image conversion unit 222 performs the parallax adjustment of the stereoscopic image by performing the image conversion with respect to the stereoscopic image. Here, the imaging device is present in which the parallax adjustment of the stereoscopic image is performed by adjusting the convergence angle (angle between optical axes of the optical system included in each imaging unit) of two imaging units by moving the optical system of the imaging unit.

Therefore, according to a second embodiment of the present technology, an example is shown in which a parallax adjustment of an imaging device which performs the parallax adjustment of a stereoscopic image by adjusting a convergence angle of two imaging units.

“Configuration Example of Imaging Device”

FIG. 10 is a block diagram which shows a configuration example of an imaging device 600 according to the second embodiment of the present technology. In addition, since the imaging device 600 is a device in which a part of the imaging device 100 in FIG. 1 is deformed, common portions to the imaging device 100 are given with the same reference numerals, and a part of descriptions thereof will be omitted.

The imaging device 600 includes an imaging unit 610 and a parallax control unit 620.

The imaging unit 610 is an imaging unit which generates a planar image including a subject by imaging the subject, and a stereoscopic image for stereoscopically showing the subject on the basis of the control of the control unit 270, and includes a first imaging unit 611 and a second imaging unit 612.

Here, the imaging unit 610 is an imaging unit which is able to change a parallax of the stereoscopic image by changing the respective optical axis directions of the first imaging unit 611 and the second imaging unit 612. That is, the imaging unit 610 is an imaging unit which is able to perform the parallax adjustment of the stereoscopic image by adjusting the convergence angle of the first imaging unit 611 and the second imaging unit 612 by moving the respective optical systems of the first imaging unit 611 and the second imaging unit 612.

The parallax control unit 620 performs a control for executing the parallax adjustment of the stereoscopic image by adjusting the convergence angle of the first imaging unit 611 and the second imaging unit 612. For example, the parallax control unit 620 limits the parallax adjustment by limiting a moving speed, or a moving acceleration when the first imaging unit 611 and the second imaging unit 612 moves, respectively, in the horizontal direction at the time of adjusting the convergence angle of the first imaging unit 611 and the second imaging unit 612. In this case, the parallax control unit 620 limits the parallax adjustment by setting the upper limit value of the moving speed, or the moving acceleration. In addition, it is possible to apply the limitation example shown in FIG. 6 regarding the limitation of the parallax adjustment. Further, the parallax control unit 620 is an example of the parallax control unit which is described in the scope of the claim of the invention.

In this manner, according to the embodiment of the present technology, it is possible to reduce a discomfort of a viewer, and to show a comfortable planar image when displaying the stereoscopic image after the parallax adjustment in the imaging device 100 as the planar image. That is, it is possible to provide image content which is easy to view for a user. In particular, it is possible to reduce, or remove a lateral vibration which stands out, when displaying the stereoscopic image which is recorded in a state of stopping the imaging device 100 as the planar image.

In addition, according to the embodiment of the present technology, an image processing device with two imaging units is shown, however, it is possible to apply the embodiment of the present technology to an image processing device which generates a stereoscopic image by one imaging unit, or three or more image units.

In addition, according to the embodiment of the present technology, an image processing device with two imaging units is exemplified, however, it is possible to apply the embodiment of the present technology to an image processing device in which one imaging unit, or a plurality of imaging units is detachably provided. In addition, it is possible to apply the embodiment of the present technology to an image processing device such as a mobile phone with imaging function, or a mobile terminal device with imaging function (for example, a smart phone).

In addition, the above described embodiment is an example for realizing the present technology, and matters according to the embodiment, and specific matters in the scope of the claim of the invention have co-relationship with each other, respectively. Similarly, the specific matters in the scope of the claim of the invention, and the matters according to the embodiment of the present technology with the same component name as that of the specific matters of the invention have co-relationship with each other, respectively. However, the technology is not limited to the embodiments, and can be realized by performing a variety of modifications to the embodiments without departing from the scope of the invention.

In addition, the processing order which is described in the above embodiment may be perceived as a method with the series of orders, or may be perceived as a recording medium which stores a program for executing the series of orders in a computer. As the recording medium, it is possible to use, for example, a CD (Compact Disc), an MD (Mini Disc), a DVD (Digital Versatile Disk), a memory card, a Blu-ray Disc (a registered trade mark), or the like.

In addition, it is possible to configure the present technology as follows.

In one non-limiting embodiment, an image processing apparatus is described that includes

a parallax control unit that adjusts a position of an object in a left image and in a right image captured by an imaging device based on detected movement of the imaging device during an imaging operation of the imaging device, wherein

said left image and said right image are configured to be displayed together as a stereoscopic image.

According to one aspect of the embodiment, the apparatus further includes

a posture detection unit that detects said detected movement as a change in posture of the imaging device.

According to another aspect,

said parallax control unit is configured to adjust the position by horizontally shifting at least one of the left image and the right image.

According to another aspect,

said parallax control unit is configured to adjust the position by scaling at least one of the left image and the right image.

According to another aspect, said parallax control unit is configured to adjust the position by horizontally shifting and scaling at least one of the left image and the right image.

According to another aspect, said parallax control unit is configured to adjust the position by different amounts at different time intervals.

According to another aspect,

the change in posture of said image processing device is one of

a change from a fixed-state to a held-state, and

a change from the held-state to the fixed state.

According to another aspect,

the posture detection unit detects the change in posture via at least one of a gyroscope and image processing.

According to another aspect, the apparatus further includes

a parallax estimation unit that generates a parallax control parameter, and

said parallax control unit adjusts said position of the object by an amount corresponding to said parallax control parameter.

According to another aspect,

said parallax control unit includes an image conversion unit that performs a parallax adjustment on said stereoscopic image,

a range of parallax adjustment is within a first range when said posture detection unit detects the imaging device to be non-stationary, and within a second range when said imaging device is detected as being stationary, said first range being larger than said second range.

According to another aspect,

a speed at which said image conversion unit makes the parallax adjustment is slower when the imaging device is stationary than when the imaging device is non-stationary.

According to another aspect,

an acceleration at which said image conversion unit makes the parallax adjustment is slower when the imaging device is stationary than when the imaging device is non-stationary.

According to another aspect,

said parallax control unit is configured to adjust the position by changing a convergence angle of the left image and the right image.

According to another aspect, said left image and said right image are images contained in a moving image file.

According to another aspect,

said parallax control unit stops adjusting said position of the object when the posture detection unit does not detect a change in posture.

According to another aspect, the apparatus further includes the imaging device,

wherein said left image and said right image are captured as 2-D images when the imaging device is stationary.

According to another aspect, the apparatus further includes

a display unit that displays at least one of the left image and the right image as a through-image.

According to another aspect,

said parallax estimation unit generates a parallax map saved in memory that maintains a parallax of pixels that configure the stereoscopic image.

In an exemplary image processing method embodiment, the method includes

adjusting with a parallax control unit a position of an object in a left image and in a right image captured by an imaging device based on detected movement of the imaging device during an imaging operation of the imaging device; and

displaying said left image and said right image together as a stereoscopic image.

In an exemplary non-transitory computer readable storage medium embodiment the storage medium has computer readable instructions stored therein that when executed by a processing circuit perform an image processing method, the method includes adjusting with a parallax control unit a position of an object in a left image and in a right image captured by an imaging device based on detected movement of the imaging device during an imaging operation of the imaging device; and

displaying said left image and said right image together as a stereoscopic image.

### REFERENCE SIGNS LIST

10 PHOTOGRAPHER
20 TRIPOD
30 RUNNER
40 MOUNTAIN
100 IMAGING DEVICE
210 IMAGING UNIT
211 FIRST IMAGING UNIT
212 SECOND IMAGING UNIT
221 IMAGE PROCESSING UNIT
222 IMAGE CONVERSION UNIT
223 DISPLAY CONTROL UNIT
224 DISPLAY UNIT
225 RECORDING CONTROL UNIT
226 CONTENT STORAGE UNIT
230 POSTURE DETECTION UNIT
240 PARALLAX ESTIMATION UNIT
250 PARALLAX CONTROL UNIT
260 OPERATION RECEPTION UNIT
270 CONTROL UNIT
600 IMAGING DEVICE
610 IMAGING UNIT
611 FIRST IMAGING UNIT
612 SECOND IMAGING UNIT
620 PARALLAX CONTROL UNIT

1. An image processing apparatus comprising:
a parallax control unit that adjusts a position of an object in a left image and in a right image captured by an imaging device based on detected movement of the imaging device during an imaging operation of the imaging device, wherein
said left image and said right image are configured to be displayed together as a stereoscopic image.

2. The image processing apparatus of claim 1, further comprising:
a posture detection unit that detects said detected movement as a change in posture of the imaging device.

3. The image processing apparatus of claim 1, wherein said parallax control unit is configured to adjust the position by horizontally shifting at least one of the left image and the right image.

4. The image processing apparatus of claim 1, wherein said parallax control unit is configured to adjust the position by scaling at least one of the left image and the right image.

5. The image processing apparatus of claim 1, wherein said parallax control unit is configured to adjust the position by horizontally shifting and scaling at least one of the left image and the right image.

6. The image processing apparatus of claim 1, wherein said parallax control unit is configured to adjust the position by different amounts at different time intervals.

7. The image processing apparatus of claim 2, wherein:
the change in posture of said image processing device is one of a change from a fixed-state to a held-state, and
a change from the held-state to the fixed state.

8. The image processing apparatus of claim 2, wherein:
the posture detection unit detects the change in posture via at least one of a gyroscope and image processing.

9. The image processing apparatus of claim 1, further comprising:
a parallax estimation unit that generates a parallax control parameter, and
said parallax control unit adjusts said position of the object by an amount corresponding to said parallax control parameter.

10. The image processing apparatus of claim 2, wherein said parallax control unit includes an image conversion unit that performs a parallax adjustment on said stereoscopic image,
a range of parallax adjustment is within a first range when said posture detection unit detects the imaging device to be non-stationary, and
within a second range when said imaging device is detected as being stationary, said first range being larger than said second range.

11. The image processing apparatus of claim 10, wherein
a speed at which said image conversion unit makes the parallax adjustment is slower when the imaging device is stationary than when the imaging device is non-stationary.

12. The image processing apparatus of claim 10, wherein
an acceleration at which said image conversion unit makes the parallax adjustment is slower when the imaging device is stationary than when the imaging device is non-stationary.

13. The image processing apparatus of claim 1, wherein
said parallax control unit is configured to adjust the position by changing a convergence angle of the left image and the right image.

14. The image processing apparatus of claim 1, wherein said left image and said right image are images contained in a moving image file.

15. The image processing apparatus of claim 2, wherein
said parallax control unit stops adjusting said position of the object when the posture detection unit does not detect a change in posture.

16. The image processing apparatus of claim 1, further comprising said imaging device, wherein said left image and said right image are captured as 2-D images when the imaging device is stationary.

17. The image processing apparatus of claim 1, further comprising:
a display unit that displays at least one of the left image and the right image as a through-image.

18. The image processing apparatus of claim 9, wherein
said parallax estimation unit generates a parallax map saved in memory that maintains a parallax of pixels that configure the stereoscopic image.

19. An image processing method comprising:
adjusting with a parallax control unit a position of an object in a left image and in a right image captured by an imaging device based on detected movement of the imaging device during an imaging operation of the imaging device; and
displaying said left image and said right image together as a stereoscopic image.

20. A non-transitory computer readable storage medium having computer readable instructions stored therein that when executed by a processing circuit perform an image processing method, the method comprising:
adjusting with a parallax control unit a position of an object in a left image and in a right image captured by an imaging device based on detected movement of the imaging device during an imaging operation of the imaging device; and
displaying said left image and said right image together as a stereoscopic image.
